(19) United States
(12) Patent Application Publication
(10) Pub. No.: US 2009/0167526 A1
(43) Pub. Date: Jul. 2, 2009

(54) LOCKBOX TAMPER DETECTION

(76) Inventors: Todd Graves, Tualatin, OR (US); Jonathan G. Hays, Newberg, OR (US); Adam Purdue, Keizer, OR (US)

Correspondence Address: KLARQUIST SPARKMAN, LLP, 121 S.W. SALMON STREET, SUITE 1600, PORTLAND, OR, 97204, US

(21) Appl. No.: 11/968,083

(22) Filed: Dec. 31, 2007

(51) Int. Cl. G08B 29/00

(52) U.S. Cl. 340/540

(57) ABSTRACT

A lockbox can comprise one or more sensors for detecting tampering with one or more portions of the lockbox. For example, in some embodiments the one or more sensors are configured to detect cutting or breaking of the shackle (or other portion of the lockbox) configured to secure the lockbox to another object. As a result of detecting tampering, a wireless communication device coupled to the lockbox transmits a notification to a monitoring station. Some embodiments of the lockbox perform detection and transmission of lockbox position data.

### FIELD

The disclosed technologies generally relate to lockboxes, for example, a lockbox containing a key for a real estate property.

### BACKGROUND

Lockboxes are typically used to a provide a secured storage area for a key or other access aid at a location close to a locked property accessible by the key. An authorized user can unlock the secured storage area, obtain the key and then use the key to unlock the locked property.

The locked property can be, for example, a home or other property that is locked (usually while unattended) by a traditional lock that requires a key. In other situations, the locked property can be a commercial or industrial site, or other type of property.

The lockbox is typically attached to a door handle or to another stationary object near the traditional lock. The lockbox is typically configured to require the user to demonstrate that he is authorized to obtain access to the locked property before the secured storage area is unlocked to allow the user to obtain the key. In a mechanical lockbox, the user might be required to enter a correct lock combination to access the secured storage area. In an electronic lockbox, the user might be required to communicate a credential to the lockbox (via a physical connection to the lockbox or via a wireless link to the lockbox) to access the secured storage area. In at least some cases, the lockbox is subject to tampering (e.g., vandalism and/or theft).

### SUMMARY

A lockbox can comprise one or more sensors (or other type of detectors) for detecting tampering with one or more portions of the lockbox. For example, in some embodiments the one or more sensors are configured to detect cutting or breaking of the shackle (or other portion of the lockbox) configured to secure the lockbox to another object. As a result of detecting tampering, a wireless communication device coupled to the lockbox transmits a notification to a monitoring station.

In some embodiments, a lockbox comprises a securable storage area for securing a key; a fastening element configured to removably fasten the lockbox to another object; a detection unit configured to detect tampering with the lockbox; and a wireless communication device coupled to the detection unit and configured to transmit a signal to a monitoring station when the detection unit detects tampering with the lockbox. A satellite navigation system receiver can be coupled to the lockbox, wherein the wireless communication device is configured to transmit lockbox location data to the monitoring station. In some embodiments, the wireless communication device is configured to transmit the lockbox location data to the monitoring station as a result of detecting tampering with the lockbox. In further embodiments, the detection unit is configured to detect tampering with the fastening element. In some cases, the fastening element comprises a shackle. In additional embodiments, the detection unit is configured to detect tampering with the storage area. In select embodiments the detection unit comprises an electrical sensor. In some embodiments the detection unit comprises a magnetic sensor. In further embodiments the detection unit comprises an accelerometer. The detection unit can be configured to transmit the signal to the monitoring station if motion detected by the accelerometer exceeds a selected time or intensity threshold. In particular embodiments the lockbox further comprises means for determining at least the approximate geographic location of the lockbox.

In some embodiments, a method of monitoring a lockbox comprises: detecting by the lockbox, in approximately real-time, one or more indications of tampering with the lockbox; and as a result of the detecting, wirelessly transmitting an alert signal from the lockbox to a monitoring station. The method can further comprise wirelessly transmitting location information to the monitoring station. The location information can be transmitted to the monitoring station at a predetermined interval. In some embodiments the method further comprises providing an indicator of the alert signal to a law enforcement agency.

In additional embodiments, a system for monitoring a lockbox at a property comprises: a lockbox comprising an area for storing a key to the property, wherein the lockbox is configured to detect tampering with the lockbox and to wirelessly transmit an indicator of the tampering approximately in real-time with the tampering; and a monitoring station configured to receive the indicator and provide a description of the indicator to a user. In at least some cases the lockbox is further configured to wirelessly transmit lockbox location information to the monitoring station.

### BRIEF DESCRIPTION OF THE DRAWINGS

FIG. 1 shows a front view of a lockbox.

FIG. 2 shows a perspective view of the lockbox of FIG. 1.

FIG. 3 shows a block diagram of an embodiment of an electronic control system for a lockbox.

FIG. 4 shows a diagram of a system for monitoring a lockbox.

FIG. 5 shows a flowchart of an embodiment of a method for monitoring a lockbox.

### DETAILED DESCRIPTION

Disclosed below are representative embodiments of a lockbox and/or related systems that should not be construed as limiting in any way. Instead, the present disclosure is directed toward all novel and nonobvious features and aspects of the various disclosed methods, apparatus, and equivalents thereof, alone and in various combinations and subcombinations with one another. The disclosed technology is not limited to any specific aspect or feature, or combination thereof, nor do the disclosed methods and apparatus require that any one or more specific advantages be present or problems be solved.

As used in this application and in the claims, the singular forms “a,” “an” and “the” include the plural forms unless the context clearly dictates otherwise. Additionally, the term “includes” means “comprises.” Moreover, unless the context dictates otherwise, the term “coupled” means physically connected or electrically or electromagnetically connected or linked and includes both direct connections or direct links and indirect connections or indirect links through one or more intermediate elements. The phrase “and/or” can mean “and,” “or” and “one or more of” the elements described in the sentence. Embodiments described herein are exemplary embodiments of the disclosed technologies unless clearly stated otherwise.

Although the operations of some of the disclosed methods and apparatus are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed methods and apparatus can be used in conjunction with other methods and apparatus.

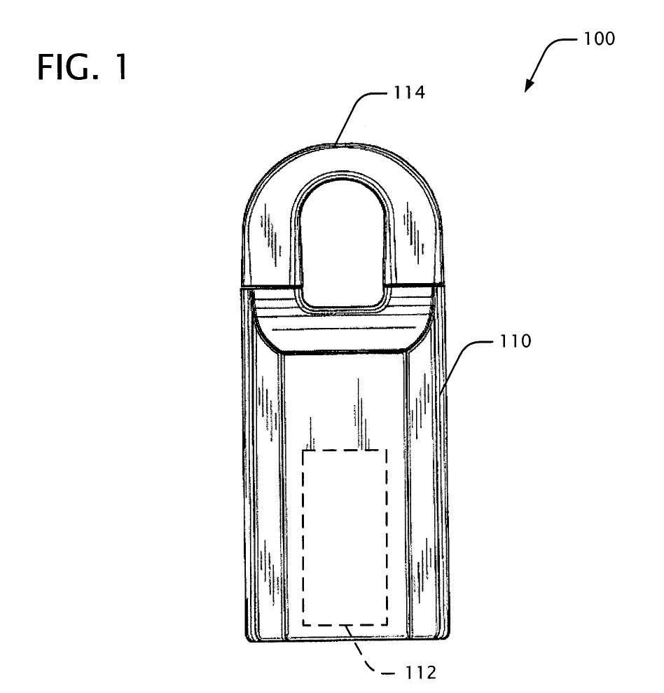

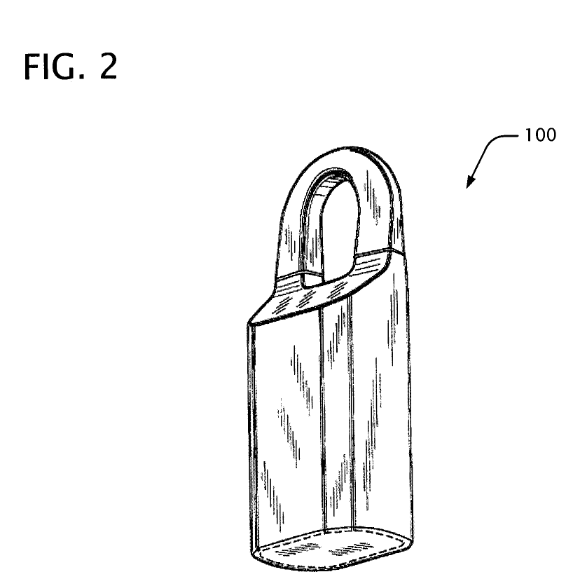

FIG. 1 shows a front view of one embodiment of a lockbox 100. The lockbox 100 comprises a housing 110 and associated components such as a key storage area 112 and an electronic control system (not shown in this view, but described in more detail below). In at least some embodiments, the housing 110 is coupled to a fastening element which is configured to secure the lockbox to a stationary object such as a doorknob or pipe. In at least some embodiments described herein the fastening element comprises a shackle (e.g., shackle 114). As exemplified by the shackle 114, in at least some embodiments not all of the components of the lockbox 100 are completely contained within the housing 110. FIG. 2 shows a perspective view of the lockbox 100.

In further embodiments, the lockbox 100 is configured to provide access to the key storage area 112 in response to the detection of and/or interaction with an access device. The access device, also called a “key” or “electronic key,” can comprise a wireless communication device (e.g., a cellular telephone, “smart” phone or other type of telephone (hereinafter “phone”)), personal digital assistant (PDA) or other personal electronic device. A dedicated access device, i.e., a device having a primary function of communicating with lockboxes, may also be used. In various embodiments, the lockbox supports additional forms of communication, such as WiFi, WiMax, ZigBee, Bluetooth, near-field and infrared (IR) communications (e.g., IrDA), to allow other forms of access devices to be used with the lockbox.

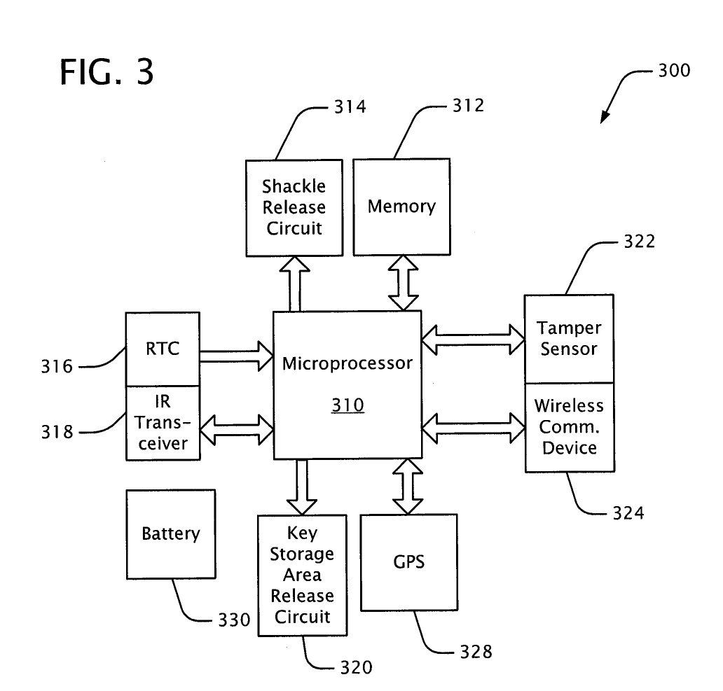

FIG. 3 shows a block diagram of one embodiment of an electronic control system 300 found in the lockbox 100. The system 300 comprises a microprocessor 310, which reads data from and/or writes data to a memory 312. The memory 312 generally comprises one or more computer-readable media (e.g., RAM, ROM, magnetic storage such as a hard drive, etc.). One or more software instructions for the microprocessor 310 can be stored in the memory 312. The microprocessor 310 is coupled to a real-time clock (RTC) 316, an IR transceiver 318, a tamper sensor 322, a wireless communication device 324, a shackle-release circuit 314, and a key storage area-release circuit 320. The shackle-release circuit 314 and the key storage area-release circuit 320 are configured to open the shackle 114 and the key storage area 112, respectively. The wireless communication device 324 comprises, for example, a cellular telephone or similar device. Some embodiments further comprise a satellite navigation system (SNS) receiver 328 (such as a global positioning system (GPS) receiver). Generally, the SNS receiver 328 and the wireless communication device 324 allow the lockbox 100 to transmit geographic location data for the lockbox 100. In some embodiments the system 300 is powered by a power source such as a battery 330. In particular embodiments, the battery 330 is provided by an electronic key and is not necessarily contained within the lockbox 100.

Generally, the tamper sensor 322 is configured to detect possible tampering with the lockbox 100. Tampering includes, for example, unauthorized attempts to access the key storage area 112 or the housing 110, unauthorized attempts to cut or open the shackle 114, and unauthorized attempts to relocate the lockbox 100. In some embodiments, the tamper sensor 322 comprises an electronic sensor configured to detect, for example, a change in current or voltage in a portion of the lockbox 110. In particular embodiments, the tamper sensor 322 is configured to detect a current or voltage in the shackle 114. Accordingly, if the shackle 114 is broken, cut or forced open, the tamper sensor 322 detects a change in current or voltage in the shackle 114. In such cases, the microprocessor 310 identifies that tampering of the lockbox 100 is occurring or has occurred. Additional embodiments of the lockbox 100 detect voltage or current changes in one or more other lockbox components (e.g., the key storage area 112 and/or the housing 110).

In further embodiments, the tamper sensor 322 comprises an accelerometer. In such embodiments, the sensor 322 is configured to detect motion of one or more parts of the lockbox 100. Generally, such a configuration can be useful for detecting if a component of the lockbox 100 is being forced or cut open using a method that generates movements not typically associated with normal use of the lockbox 100. For example, someone may attempt to use a power tool to cut the shackle 114 so that the lockbox 100 can be moved to another location. Typically, the application of the power tool to the lockbox 100 would result in the tamper sensor 322 detecting unusually long and/or intense vibrations on one or more lockbox components. In cases where the detected movements exceed predetermined thresholds, the microprocessor 310 identifies that tampering of the lockbox 100 is occurring or has occurred. In some embodiments the thresholds are stored in the memory 312. The thresholds can be provided to the lockbox 100 locally or remotely.

In further embodiments, the tamper sensor 322 comprises a magnetic sensor. In such embodiments, the sensor 322 is configured to detect if one or more magnets are being used to manipulate internal components of the lockbox 100 (e.g., one or more components that can open the shackle 114 and/or the key storage are 112).

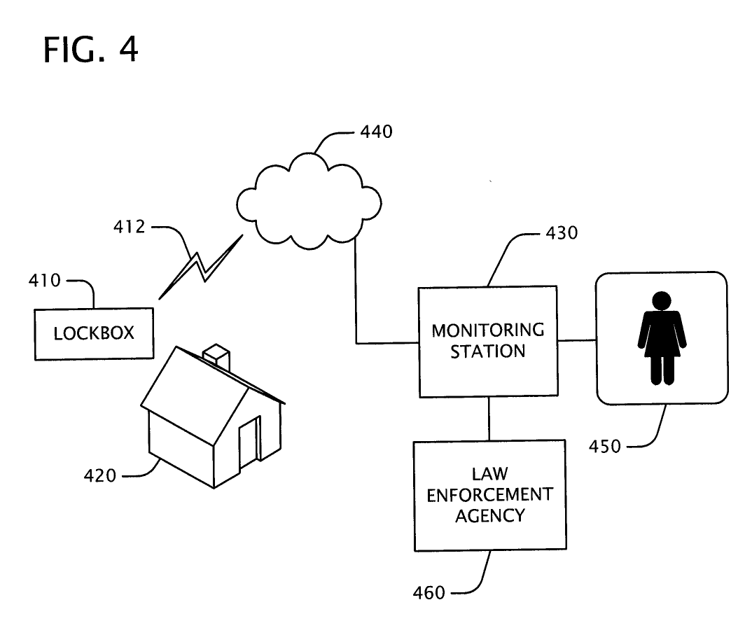

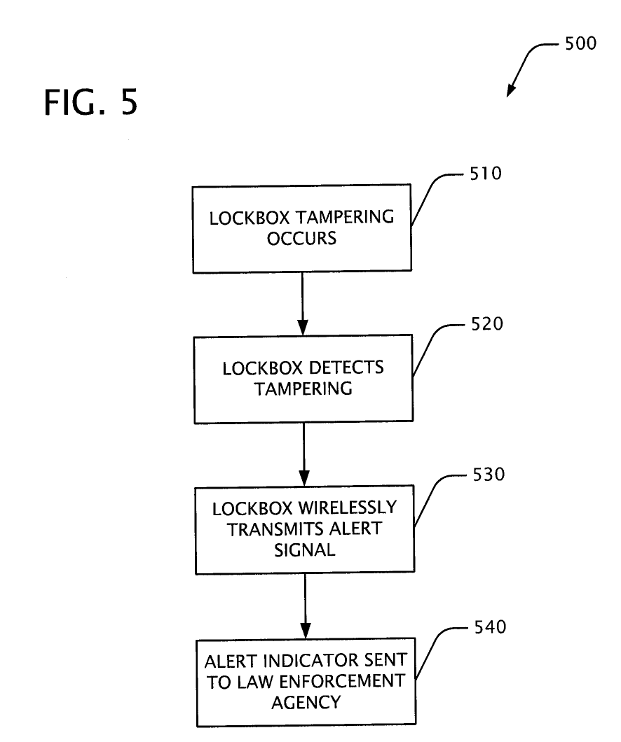

FIG. 4 shows a diagram of an embodiment of a system for monitoring a lockbox 410 at a property 420. The lockbox 410 is similar to the lockbox 100 described above. FIG. 5 shows a flowchart of an embodiment of a method 500 for monitoring the lockbox 410 in conjunction with, for example, the system of FIG. 4. In a method act 510, lockbox tampering occurs. The microprocessor 310 in the lockbox 410 detects that the tampering is occurring or has occurred in a method act 520 and wirelessly transmits an alert signal in a method act 530. FIG. 4 shows the lockbox 410 transmitting a signal 412 to a monitoring station 430, which in some embodiments is remotely located from the lockbox 410. The signal 412 can be sent in real-time or approximately in real-time with the detection of the tampering. In select embodiments, the signal 412 comprises an indication that tampering with the lockbox 410 has been detected. In further embodiments, the signal 412 comprises one or more details regarding the nature of the detected tampering (e.g., one or more parts of the lockbox to which the tampering is related). In some embodiments, the signal 412 is sent via a wireless communication network 440. The monitoring station 430 comprises one or more computers (not shown) configured to receive data from the lockbox 410. In particular embodiments, as a result of receiving the signal 412, the monitoring station 430 can provide an indicator (e.g., an alert signal) to a human operator 450. The indicator can be provided to the human operator 450 by a variety of communication systems (e.g., wired or wireless). In further embodiments, in a method act 540 the monitoring station 430 provides the indicator to a law enforcement agency 460.

In particular embodiments the signal 412 comprises location data for the lockbox 410. However, in some embodiments the lockbox 410 sends location data to the monitoring station 430 independently of whether any tampering with the lockbox 410 has been detected. In further embodiments, the lockbox 410 sends location data to the monitoring station 430 multiple times (e.g., periodically) after tampering is detected. This can allow, for example, for tracking of the lockbox 410 to determine if the lockbox 410 has been moved after the tampering has occurred. In additional embodiments, the lockbox 410 is configured to detect unauthorized movement of the lockbox 410 from one location to another (e.g., based on the lockbox location data) independent of tampering detected by the tamper sensor 322. If unauthorized movement is detected, the lockbox 410 can transmit an alert signal. The lockbox 410 can determine if detected movement of the lockbox 410 is authorized based on, for example, whether or not the lockbox 410 has received an indicator authorizing lockbox movement. In further embodiments, the monitoring station 430 determines at least in part if a detected movement of the lockbox 410 is unauthorized.

At least some embodiments of the technologies described above can allow for a user of a lockbox to remotely determine a potential or actual problem with the lockbox rather than, for example, first becoming aware of the problem upon physical inspection of the lockbox. This can help the user avoid situations where, for example, tampering with a lockbox is not discovered until a property is visited by the user, perhaps with a client. Potentially, the technologies can be used to help discover and/or apprehend those performing and/or aiding in the tampering. In some embodiments, the lockbox 410 transmits location data and/or sensor data in response to a request from a user (e.g., a realtor) and/or from the monitoring station 430. The request can be sent to the lockbox 410 via a web page or other user interface.

In view of the many possible embodiments to which the principles of the disclosed technologies can be applied, it should be recognized that the illustrated embodiments are only preferred examples of the technologies and should not be taken as limiting the scope of the invention. Rather, the scope of the invention is defined by the following claims. We therefore claim as our invention all that comes within the scope and spirit of these claims.

We claim:

1. A lockbox comprising:
a securable storage area for securing a key;
a fastening element configured to removably fasten the lockbox to another object;
a detection unit configured to detect tampering with the lockbox; and
a wireless communication device coupled to the detection unit and configured to transmit a signal to a monitoring station when the detection unit detects tampering with the lockbox.

2. The lockbox of claim 1, further comprising a satellite navigation system receiver coupled to the lockbox, wherein the wireless communication device is configured to transmit lockbox location data to the monitoring station.

3. The lockbox of claim 2, wherein the wireless communication device is configured to transmit the lockbox location data to the monitoring station as a result of detecting tampering with the lockbox.

4. The lockbox of claim 1, wherein the detection unit is configured to detect tampering with the fastening element.

5. The lockbox of claim 1, wherein the fastening element comprises a shackle.

6. The lockbox of claim 1, wherein the detection unit is configured to detect tampering with the storage area.

7. The lockbox of claim 1, wherein the detection unit comprises an electrical sensor.

8. The lockbox of claim 1, wherein the detection unit comprises a magnetic sensor.

9. The lockbox of claim 1, wherein the detection unit comprises an accelerometer.

10. The lockbox of claim 9, wherein the detection unit is configured to transmit the signal to the monitoring station if motion detected by the accelerometer exceeds a selected time or intensity threshold.

11. The lockbox of claim 1, further comprising means for determining at least the approximate geographic location of the lockbox.

12. A method of monitoring a lockbox comprising:
detecting by the lockbox, in approximately real-time, one or more indications of tampering with the lockbox; and
as a result of the detecting, wirelessly transmitting an alert signal from the lockbox to a monitoring station.

13. The method of claim 12, further comprising wirelessly transmitting location information to the monitoring station.

14. The method of claim 13, wherein the location information is transmitted to the monitoring station at a predetermined interval.

15. The method of claim 12, further comprising providing an indicator of the alert signal to a law enforcement agency.

16. A system for monitoring a lockbox at a property, the system comprising:
a lockbox comprising an area for storing a key to the property, wherein the lockbox is configured to detect tampering with the lockbox and to wirelessly transmit an indicator of the tampering approximately in real-time with the tampering; and
a monitoring station configured to receive the indicator and provide a description of the indicator to a user.

17. The system of claim 16, wherein the lockbox is further configured to wirelessly transmit lockbox location information to the monitoring station.
